(19) United States
(12) Patent Application Publication
(10) Pub. No.: US 2011/0096568 A1
(43) Pub. Date: Apr. 28, 2011

(54) Modular LED edge merchandising system

(76) Inventors: Richard Schattinger, New York, NY (US); Derek J. Gabriels, Bay Shore, NY (US)

(21) Appl. No.: 12/607,839

(22) Filed: Oct. 28, 2009

(51) Int. Cl. F21V 7/22

(52) U.S. Cl. 362/613

(57) ABSTRACT

The present invention may include a display for displaying objects including a mounting panel for mounting a light panel including a LED light, a graphics panel adjacent to the light panel which may include information to be displayed, a magnetic shelf being magnetically attracted to the mounting panel and being detachably connected to the display for displaying objects. The display may include a protective screen adjacent to the graphics panel to protect and hold the graphics panel, and the display may include an first array of LED lights. The first array of LED lights may be positioned down a peripheral edge of the light pane, and the light panel may include a first groove. The first groove may be a horizontal groove, and the light panel may include a second groove. The second groove may be vertical groove, and the light panel may include a second array of LED lights. The second array of LED lights may be positioned on opposing edge of the light panel, and the magnetic shelf may be substantially L-shaped. The magnetic shelf may be substantially Z-shaped, and the magnetic shelf may be a hanger.

### FIELD OF THE INVENTION

This invention is directed to an edge-lit backlighting system for light emitting diode displays, and, more particularly, to a backlighting system employing a number of light strips in the form of thin, light weight sections of a substrate each of which mounts a plurality of light engines having an array of densely packed, primary color light emitting diodes (“LEDs”).

### BACKGROUND

In recent years, there have been developed light-emitting diodes capable of emitting red, green, and blue colors (hereinafter referred to as “RGB” in some cases) and light-emitting diodes which are formed of light emitting elements in combination with phosphor materials so that they emit various colors, such as a white color, with a high brightness. Since a light-emitting diode (hereinafter referred to as an “LED”) is a solid-state element, it has superior resistance against vibration, a low-power consumption rate, a long operating life, and superior drive properties such as a high-speed drive. Accordingly, the light-emitting diodes have been increasingly used for various applications such as light sources for signal heads and full-color LED displays.

Light-emitting diode devices having various sizes and display effects have been developed and are available in the market. Depending on the complexity of required illumination pattern, most of the light-emitting diode devices include arrays of light-emitting diodes selectively switched on/off to generate such illumination pattern. When a complex illumination pattern is desired, the number of required light-emitting diodes can be significant. In addition, when the light-emitting diode devices are applied to an educational toy, the educational value is limited to the image only.

Most displays are two-dimensional screen which show the product and may or may not include animation. These displays lack the ability to capture the attention of the public.

### SUMMARY

The present invention may include a display for displaying objects including a mounting panel for mounting a light panel including a LED light, a graphics panel adjacent to the light panel which may include information to be displayed, a magnetic shelf being magnetically attracted to the mounting panel and being detachably connected to the display for displaying objects.

The display may include a protective screen adjacent to the graphics panel to protect and hold the graphics panel, and the display may include an first array of LED lights.

The first array of LED lights may be positioned down a peripheral edge of the light pane, and the light panel may include a first groove.

The first groove may be a horizontal groove, and the light panel may include a second groove.

The second groove may be vertical groove, and the light panel may include a second array of LED lights.

The second array of LED lights may be positioned on opposing edge of the light panel, and the magnetic shelf may be substantially L-shaped.

The magnetic shelf may be substantially Z-shaped, and the magnetic shelf may be a hanger.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of the display of the present invention;

FIG. 2 illustrates a front view of the protective screen of the display of the present invention;

FIG. 3 illustrates a front view of the graphics panel of the display of the present invention;

FIG. 4 illustrates a front view of the light panel of the display of the present invention;

FIG. 5 illustrates a perspective view of the light panel of the display of the present invention;

FIG. 6 illustrates a front view of the light panel of the present invention;

FIG. 7 illustrates a side view of the light panel of the present invention;

FIG. 8 illustrates a perspective view of the display of the present invention;

FIG. 9 illustrates a perspective view of the display of the present invention;

FIG. 10 illustrates a perspective view of the mounting panel of the present invention positioned on a base;

FIG. 11 illustrates a perspective view of a shelf of the present invention;

FIG. 12 illustrates a front perspective view of a shelf of the present invention;

FIG. 13 illustrates a back view of the shelf of the present invention;

FIG. 14 illustrates a top view of the shelf of the present invention;

FIG. 15 illustrates a side view of the shelf of the present invention;

FIG. 16 illustrates a front view of the shelf of the present invention;

FIG. 17 illustrates a perspective view of a hangar of the present invention;

FIG. 18 illustrates a side view of the hangar of the present invention;

FIG. 19 illustrates a front view of the hangar of the present invention;

FIG. 20 illustrates a perspective view of a display of the present invention.

### DETAILED DESCRIPTION

The present invention employs a display which includes a screen which may be lit by LED lights in order to achieve sufficient lighting and may include a metal mounting panel in order to allow a magnetic shelf to be detachably connected to the display. The shelf provides the ability for samples such as merchandise to be placed on the shelf in order to attract attention to the display and to allow the screen to disclose pertinent information to the prospective buyer in order to enhance the desire for a purchase for the sample or object. In some cases, the object or sample can be magnetized in order that the sample or object can be directly held by magnetic force to the screen.

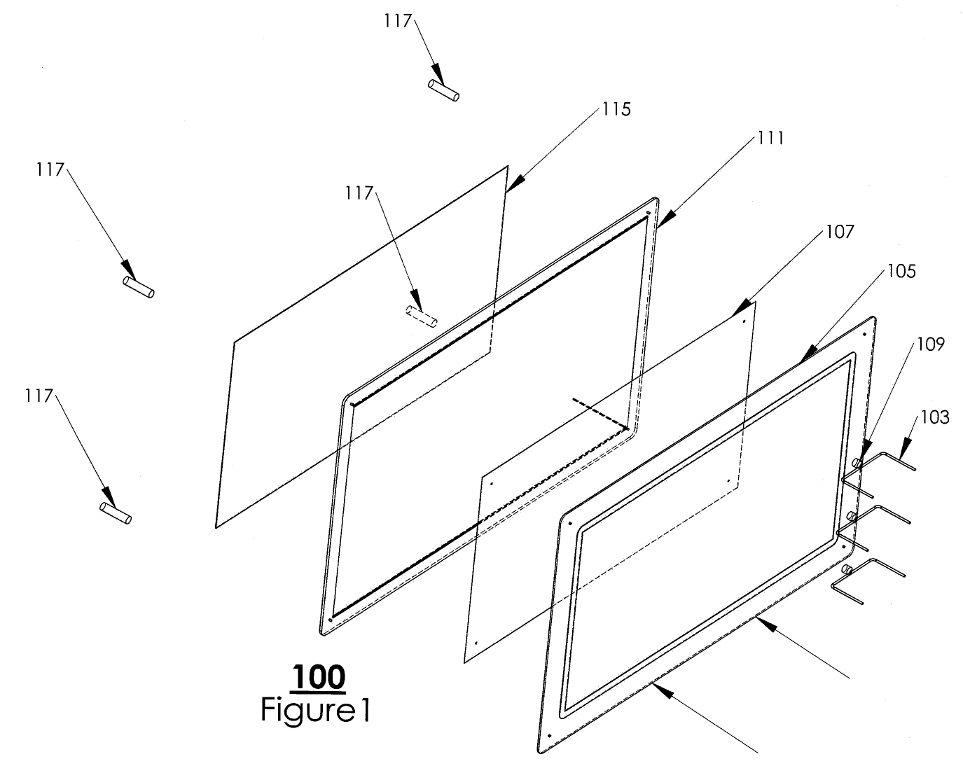

FIG. 1 illustrates an exploded view of the display 100 of the present invention. The display 100 may be used to provide a visual display of information which may be information about a product to be merchandised. The display of the present invention may include a shelf 103 to hold and display objects 101 which may be a sample of the information of the display 100. The shelf 103 may be magnetically detachably connected to a protective screen 105 which may protect a graphic panel 107 which may include information which may include a image that is related to the object 101. The graphic panel 107 may be adjacent to a light panel 111 which may include LED lights 113 which may be formed in an array to generate a substantially white light and which may extend along at least one peripheral edge of the light panel 111. The light panel 111 may include a second array of LED lights 113 which may be positioned along an opposing peripheral edge of the light panel 111. The light panel 111 may be positioned on a mounting panel 115 which may be metallic in order to cooperate with the magnetic force generated by the magnets 109 positioned on the shelf 103. The mounting panel 115, the light panel 111 the graphic panel 107 and the protective screen 105 may include mounting apertures which may be aligned in order to cooperate with a mounting device 117 which may include rods which may extend perpendicular to the plane of the mounting panel 115, the light panel 111, the graphics panel 107 and the protective screen 105 in order to position the mounting panel 115, the light panel 111, the graphics panel 107 and the protective screen 105. The graphic panel 107 may include a white film.

The mounting panel 115 may be a substantial rectangle or other appropriate shape and may be substantially rigid, and the mounting panel 115 may be positioned adjacent and coextensive with the light panel 111 which may be substantially rectangular and may be substantially rigid. The light panel 111 may be positioned adjacent and substantially coextensive with the graphics panel 107 to provide a backlight for the graphics panel 107 so that the information and images formed on the graphics panel 107 may be displayed to the user. The graphics panel 107 may be substantially transparent except where the information to be displayed is located. The graphics panel 107 may be substantially rigid and substantially rectangular and substantially coextensive with the protective screen 105 which may be substantially transparent.

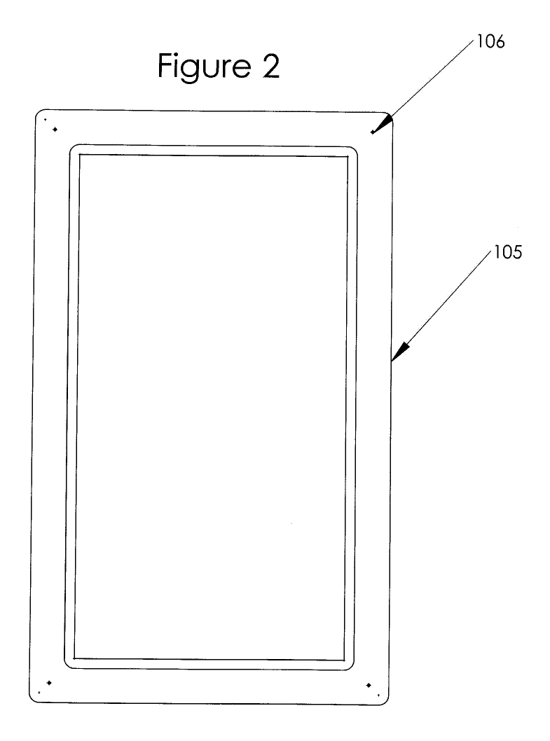

FIG. 2 illustrates a front view of the protective screen 105 and illustrates apertures 106 which may be used to cooperate with the mounting device 117.

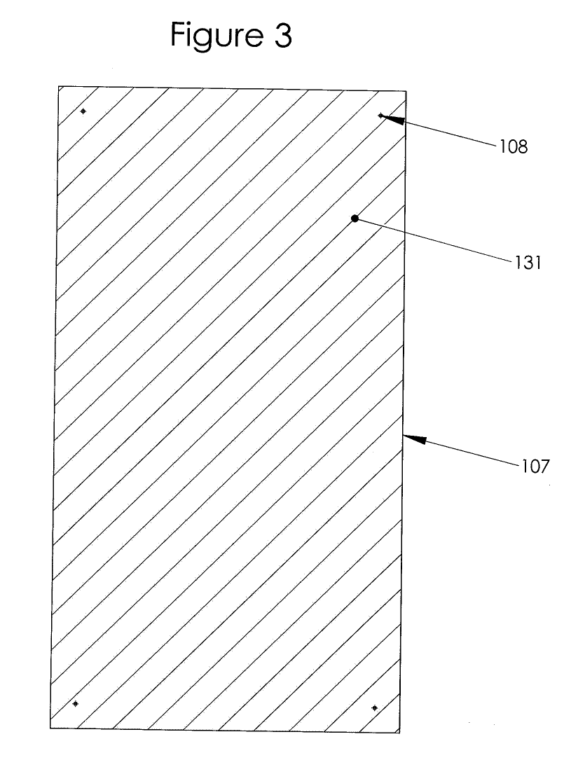

FIG. 3 illustrates a front view of the graphics panel 107 and includes a image 131 to be displayed and also includes apertures 108 to cooperate with the mounting device 117.

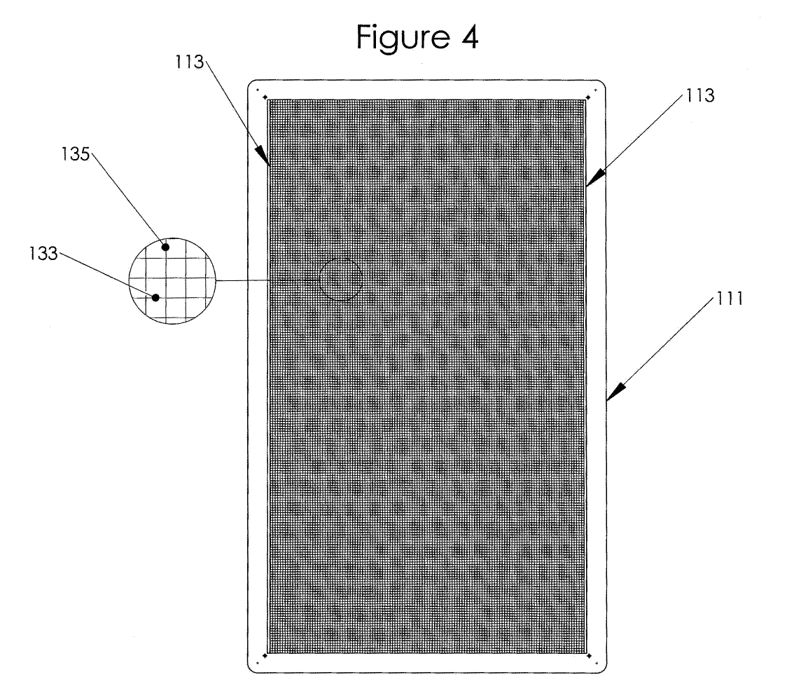

FIG. 4 illustrates a front view of the light panel 117 which may include an array of LED lights 113 positioned along the periphery of the light panel 117 and may include a second array of LED lights 113 positioned on an opposing periphery of the light panel 117. The light panel 117 may be formed from transparent material and may include a vertical grooves 135 and horizontal grooves 133 which may facilitate the distribution of the light from the array of LED lights 113. The vertical grooves 135 and the horizontal grooves 133 may be formed from a laser (not shown) or other suitable device. The substrate of the light panel 117 may be formed from acrylic which may include a mat surface or milky white diffuser panel/paper to diffuse the light from the LEDs substantially evenly across the surface to provide a bright, uniformly illuminated presentation.

The light panel 117 may include side firing LEDs which may focus the emitting light into a light guide. The present invention may employ to one of several edge-lighting, light-extraction technologies such as printing, etching (for example by using chemicals), forming a V shaped groove by stamping, laser or other appropriate devices in forming the light guide. The light guide may be formed with individual pixels of LED lights. The LED lights may be red, green, blue or white (white phosphor).

FIG. 5 illustrates a perspective view of the back of the light panel 111 and illustrates a power cord 139 which may extend from the back of the light panel 111. The surface which includes the horizontal grooves 133 and the vertical grooves 135 may define a border area generally along the periphery of the light panel 111 which may be substantially free from grooves and may be substantially clear to form a border 137 for the light panel 111.

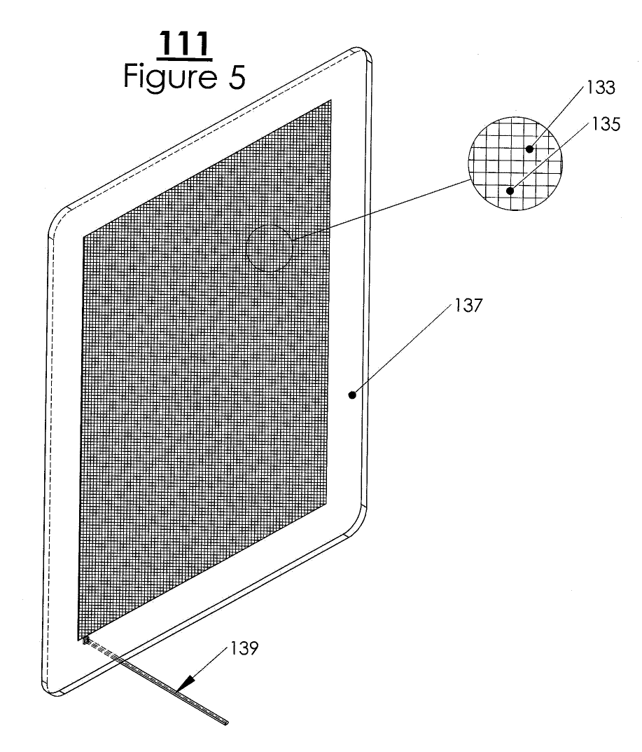

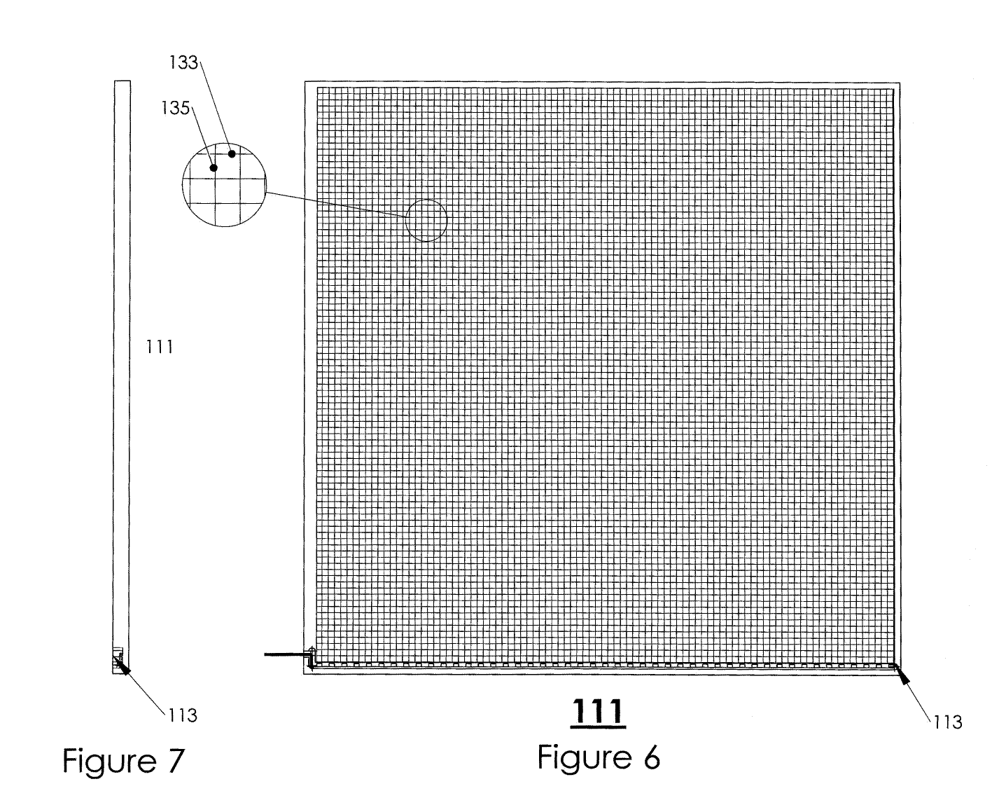

FIG. 6 illustrates a front view of the light panel 111 and illustrates the horizontal groove 113, the vertical groove 131 and the power cord 139. An array of LED lights extends across the top edge of the light panel 111.

FIG. 7 illustrates a side view of the light panel 111 and illustrates the array of LED lights 113.

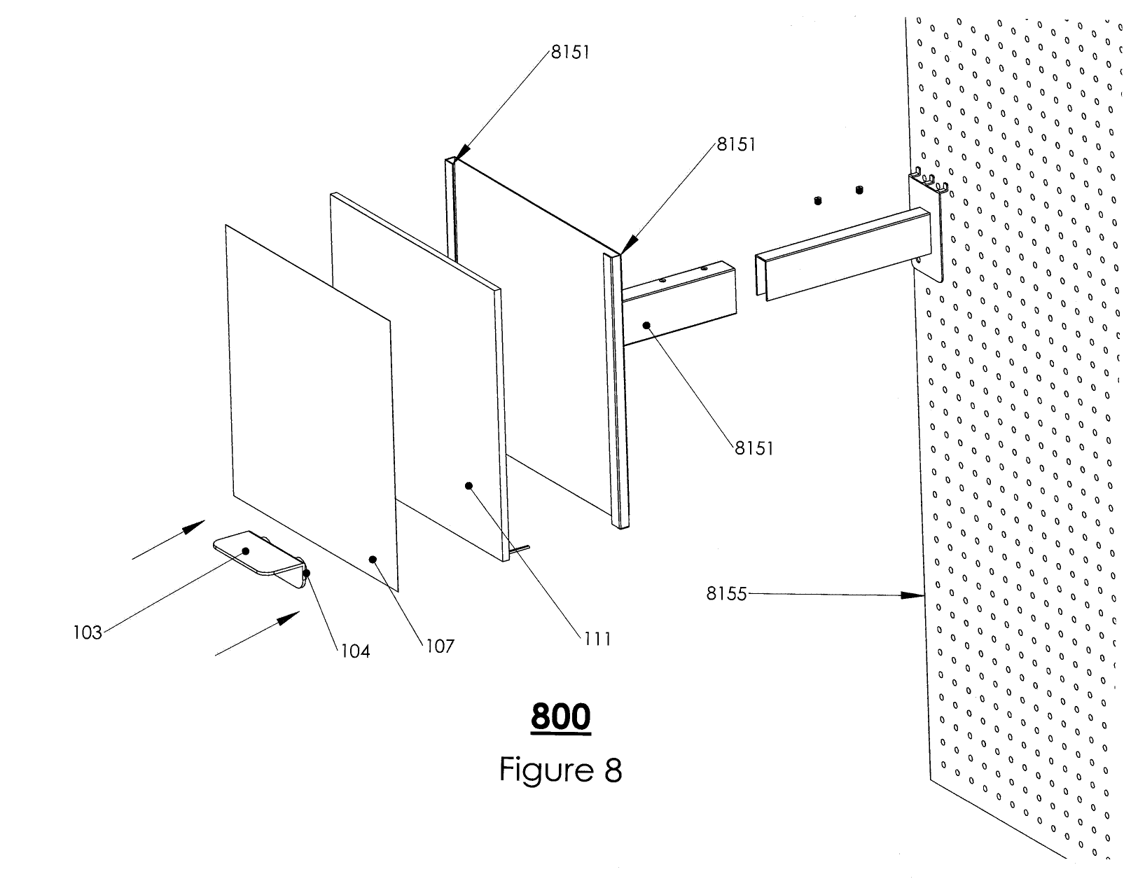

FIG. 8 illustrates another display 800 which is shown in an exploded view, and FIG. 8 illustrates a mounting panel 8115 which may be movable and extendable and may be connected to a telescoping arm 8151 which may extend and retract and may be connected to a support surface 8155. The mounting panel 8115 may include a pair of opposing vertical channels 8151 to cooperate with the light panel 111, the graphics panel 107 and the optional protective screen 105 (not shown in FIG. 8). FIG. 8 additionally illustrates the shelf 103 which may include magnets 109 to magnetically be detachably connected to the display 800 by cooperating with the mounting panel 8115 which may be formed from magnetic material such as metal. FIG. 8 illustrates a shelf 103 which may be substantially L-shaped or other shapes are within the scope of the invention.

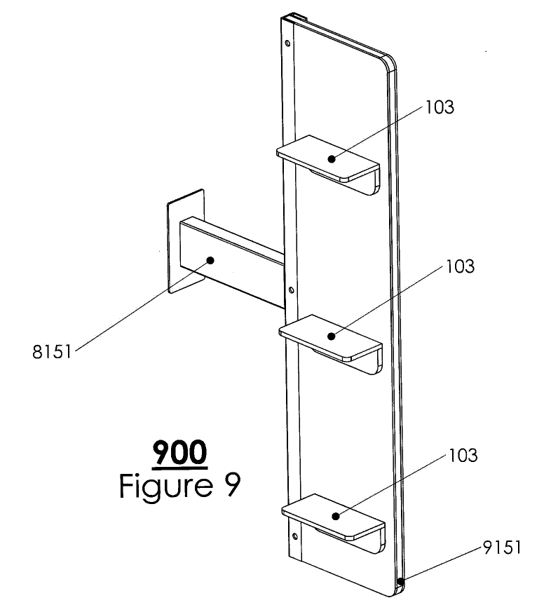

FIG. 9 illustrates the display 900 being positioned in a different orientation with respect to the display 800 (illustrated in FIG. 8). The mounting panel 9151 has been rotated 90° so that the plane of the mounting panel 9151 is within the longitudinal direction of the telescoping arm 8151.

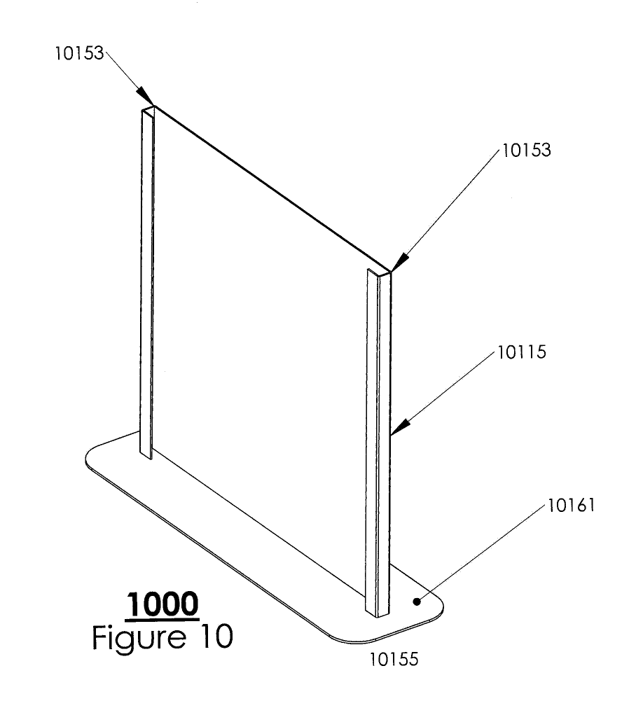

FIG. 10 illustrates another display 1000 which may include a base 10161 to be positioned on a support surface 10155, and the base 10161 may be connected to a mounting panel 10115 which may include a pair of opposing channels 10153 hold the light panel 111, the graphics panel 107 and the protective screen 105. The support surface 10115 may be a desk, a cabinet or the floor or other appropriate support surface.

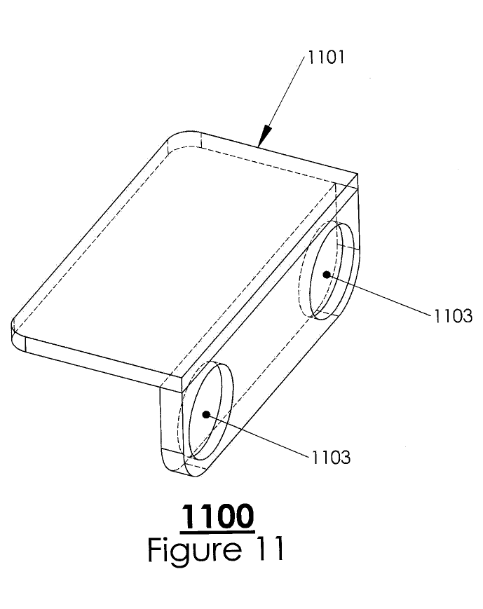

FIG. 11 illustrates a perspective view of a L-shaped shelf 1100 which may include a first and second aperture 1103 to mount a magnet for attachment to the mounting panel 1150.

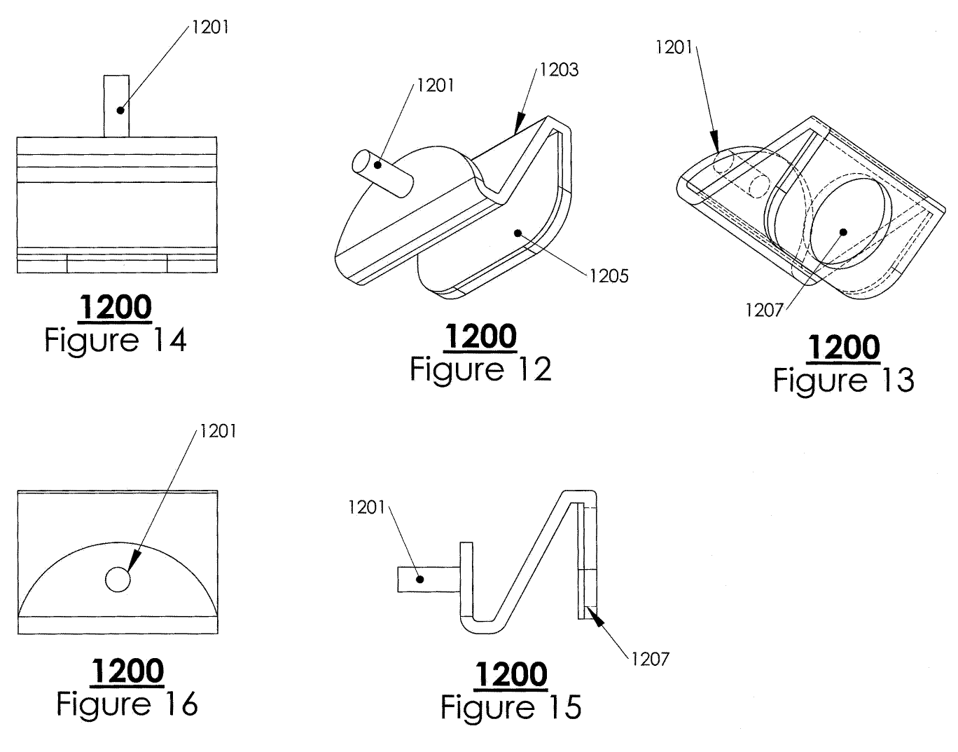

FIG. 12 illustrates a perspective view of a shelf 1200 which may include a Z-shaped portion 1203 and a horizontal arm 1201 which extends outwards from the shelf 1200. The horizontal arm 1201 is advantageous for holding objects such as clothing. The back 1205 of the shelf 1200 may include a aperture 1207 for a magnet to cooperate with the mounting panel 1150.

FIG. 13 illustrates a perspective view of the back of the shelf 1200 and illustrates the aperture 1207.

FIG. 14 illustrates a bottom view of the shelf 1200 and illustrates the horizontal arm 1201.

FIG. 15 illustrates a side view of the shelf 1200 and illustrates the horizontal arm 1201.

FIG. 16 illustrates a front view of the shelf 1200 and illustrates the horizontal arm 1201.

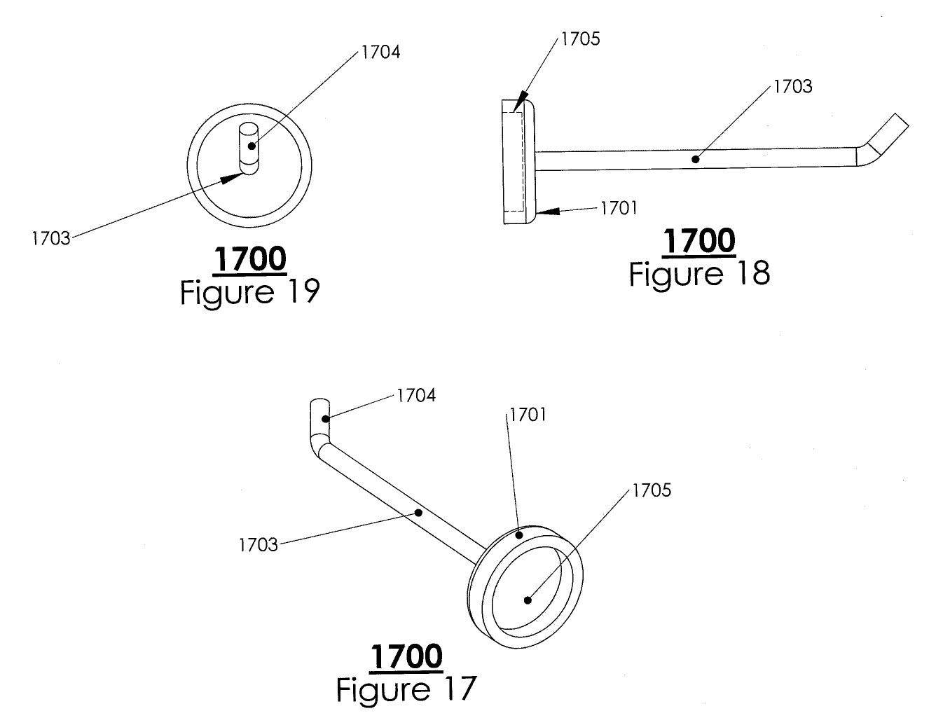

FIG. 17 illustrates a hanger 1700 which may be detachably connected to the mounting panel 115 by magnetic force and illustrates that the hanger 1700 may include a substantially circular base 1701 having a cavity for mounting a magnet and may not extend through the base 1701 and may include a arm 1703 having an inclined portion 1704.

FIGS. 18 and 19 illustrate a hanger 1700 which may be detachably connected to the mounting panel 115 by magnetic force and illustrates that the hanger 1700 may include a substantially circular base 1701 having a cavity for mounting a magnet and may include a arm 1703 having an inclined portion 1704.

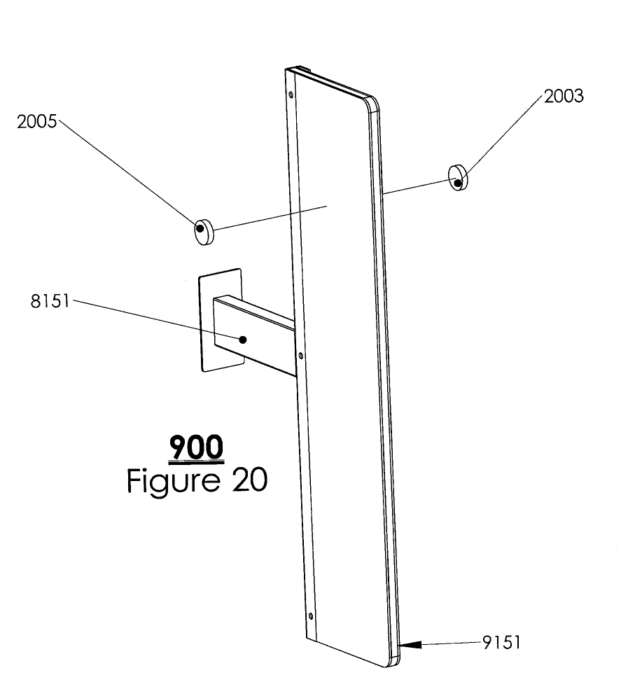

FIG. 20 illustrates the display 2000 being positioned in a similar orientation with respect to the display 900 (illustrated in FIG. 9). FIG. 20 additionally illustrates a first magnet 2003 on a first side of the mounting panel 9151 and an opposing second magnet 2005 on a second side of the mounting panel 9151. The two magnets 2003, 2005 may be magnetically attracted to the mounting panel 9151 and magnetically attracted to each other. Alternatively, either the first magnet 2003 or the second magnet 2005 may be replaced with a shelf 103 as illustrated in FIG. 9.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A display for displaying objects, comprising;
a mounting panel for mounting a light panel including a LED light;
a graphics panel adjacent to the light panel which may include information to be displayed;
a magnetic shelf being magnetically attracted to the mounting panel and being detachably connected to the display for displaying objects.

2) A display for displaying objects as in claim 1, wherein the display includes a protective screen adjacent to the graphics panel to protect and hold the graphics panel.

3) A display for displaying objects as in claim 1, wherein the display includes an first array of LED lights.

4) A display for displaying objects as in claim 3, wherein the first array of LED lights is positioned down a peripheral edge of the light panel.

5 A display for displaying objects as in claim 1, wherein the light panel includes a first groove.

6) A display for displaying objects as in claim 5, wherein the first groove is a horizontal groove.

7) A display for displaying objects as in claim 5, wherein the light panel includes a second groove.

8) A display for displaying objects as in claim 7 wherein the second groove is a vertical groove.

9) A display for displaying objects as in claim 3, wherein the light panel includes a second array of LED lights.

10) A display for displaying objects as in claim 9, wherein the second array of LED lights is positioned on opposing edge of the light panel.

11) A display for displaying objects as in claim 1, wherein the magnetic shelf is substantially L-shaped.

12) A display for displaying objects as in claim 1, wherein the magnetic shelf is substantially Z-shaped.

13) A display for displaying objects as in claim 1, wherein the magnetic shelf is a hanger.
